(19) United States
(12) Patent Application Publication
(10) Pub. No.: US 2023/0347470 A1
(43) Pub. Date: Nov. 2, 2023

(54) PAD FOR CHEMICAL MECHANICAL POLISHING

(71) Applicant: Rohm and Haas Electronic Materials CMP Holdings, Inc., Newark, DE (US)

(72) Inventors: Matthew R. Gadinski, Newark, DE (US); Joseph So, Wilmington, DE (US); Donna M. Alden, Bear, DE (US)

(21) Appl. No.: 17/661,077

(22) Filed: Apr. 28, 2022

(51) Int. Cl. B24B 37/24

(52) U.S. Cl. CPC B24B 37/24

(57) ABSTRACT

A polishing pad suitable for polishing at least one of semiconductor, optical, magnetic or electromechanical substrates comprises: a polishing layer including a polyurea having a soft phase and a hard phase, the soft phase being a copolymer of aliphatic fluorine-free species and a fluorinated aliphatic species, the polyurea being cured with a curing agent where the hard phase comprises crystallinity where the polyurea is characterized by a melting point of at least 230° C. and a ΔH_{f} of at least 3 Joule/gram as determined by Dynamic Scanning Calorimetry of the polyurea

### FIELD OF THE INVENTION

The field of this invention is chemical mechanical polishing and pads useful in chemical mechanical polishing.

### BACKGROUND

Chemical Mechanical Planarization (CMP) is a variation of a polishing process that is widely used to flatten, or planarize, the layers of construction of an integrated circuit in order to precisely build multilayer-three-dimensional circuitry. The layer to be polished is typically a thin film (less than 10,000 Angstroms) that has been deposited on an underlying substrate. The objectives of CMP are to remove excess material on the wafer surface to produce an extremely flat layer of a uniform thickness, the uniformity extending across the entire wafer area. Control of removal rate and the uniformity of removal are of paramount importance.

CMP utilizes a liquid, often called slurry, which contains nano-sized particles. This is fed onto the surface of a rotating multilayer polymer sheet, or pad, which is mounted on a rotating platen. Wafers are mounted into a separate fixture, or carrier, which has a separate means of rotation, and pressed against the surface of the pad under a controlled load. This leads to a high rate of relative motion between the wafer and the polishing pad (i.e., there is a high rate of shear at both the substrate and the pad surface. Slurry particles trapped at the pad/wafer junction abrade the wafer surface, leading to removal. In order to control rate, prevent hydroplaning, and to efficiently convey slurry under the wafer, various types of texture are incorporated into the upper surface of the polishing pad. Fine scale texture is produced by abrading the pad with an array of fine diamonds. This is done to control and increase removal rate, and is commonly referred to as conditioning. Larger scale grooves of various patterns and dimensions (e.g., XY, circular, radial) are also incorporated for hydrodynamic and slurry transport regulation.

Removal rate during CMP is widely observed to follow the Preston Equation, Rate=Kp*P*V, where P is pressure of pad on substrate, V is velocity of pad relative to substrate, and Kp is the so-called Preston Coefficient. The Preston Coefficient is a lumped sum constant that is characteristic of the consumable set being used. Several of the most important effects contributing to Kp are as follows: (a) pad contact area (largely derived from pad texture and surface mechanical properties); (b) the concentration of slurry particles on the contact area surface available to do work; and (c) the reaction rate between the surface particles and the surface of the layer to be polished. Effect (a) is largely determined by pad properties and the conditioning process. Effect (b) is determined by both pad and slurry, while effect (c) is largely determined by slurry properties.

The advent of high capacity multiple layer memory devices (e.g., 3D NAND flash memory) has led to a need for further increases in removal rate. The critical part of the 3D NAND manufacturing process consists of building up multilayer stacks of SiO₂ and Si₃N₄ films in an alternating fashion in a pyramidal staircase fashion. Once completed, the stack is capped with a thick SiO₂ overlayer, which must be planarized prior to completion of the device structure. This thick film is commonly referred to as the Pre-Metal Dielectric (PMD). The device capacity is proportional to the number of layers in the layered stack. Current commercial devices use 32 and 64 layers, and the industry is rapidly moving to 128 layers. The thickness of each oxide/nitride pair in the stack is approximately 125 nm. Thus, the thickness of the stack increases directly with the number of layers (32=4,000 nm, 64=8,000 nm, 128=16,000 nm). For the PMD step, the total amount of capping dielectric to be removed is approximately equal to approximately 1.5 times the stack thickness, assuming a conformal deposition of the PMD.

Conventional dielectric CMP slurries have removal rates of approximately 250 nm/min. This yields undesirably lengthy CMP process times for the PMD step, which now is the primary bottleneck in the 3D NAND manufacturing process. Consequently, there has been much work on developing faster CMP processes. Most improvements have focused on process conditions (higher P and V), changing the pad conditioning process, and improvements in slurry design, particularly in ceria-based slurries.

Certain pads show a benefit in removal rate from a higher downforce up to a certain pressure (or down force) after which the removal rate can plateau or even decrease. An improved pad that could be used at higher pressures and optionally paired with ceria slurries to achieve higher removal rate without introducing any negative effects would constitute a significant improvement in CMP technology.

### SUMMARY OF THE INVENTION

Disclosed herein is a polishing pad suitable for polishing at least one of semiconductor, optical, magnetic or electromechanical substrates comprising: a polishing layer including a polyurea having a soft phase and a hard phase, the soft phase being a copolymer of aliphatic fluorine-free species and a fluorinated aliphatic species, the polyurea being cured with a curative agent where the hard phase comprises crystallinity where the polyurea is characterized by a melting point of at least 230° C. and a ΔHf of at least 3 Joule/gram as determined by Dynamic Scanning Calorimetry of the polyurea.

### BRIEF DESCRIPTION OF THE DRAWINGS

Referring now to the figures, which are exemplary embodiments, and wherein the like elements are numbered alike.

FIG. 1 is a DSC thermograph showing the performance of various fluorinated polyureas.

FIG. 2 is a graph of removal rate versus downforce pressure at 90 rotations per minute (rpm) platen speed for comparative and inventive pads.

FIG. 3 is a graph of removal rate versus downforce pressure at 90 rotations per minute (rpm) platen speed for comparative and inventive pads.

### DETAILED DESCRIPTION

The polishing pad disclosed herein is suitable for polishing at least one of semiconductor, optical, magnetic or electromechanical substrates. The polishing layer of the polishing pad comprises a polyurea having hard and soft phases. The soft phases comprise segments formed using a fluorine-containing aliphatic macromolecule in relatively low concentration (approximately 1-20 weight percent (wt %) of the total soft segment based on total weight of the soft segment) and a non-fluorinated aliphatic macromolecule. The hard phase includes crystallinity as indicated by a melting temperature (Tm) of at least 230° C. and an enthalpy of formation (ΔHf) of at least 3, at least 3.5, or at least 4 Joule/gram as determined by Dynamic Scanning Calorimetry. The Tm can be up to a temperature below the degradation temperature of the polymer, for example up to 300, up to 280, up to 275, or up to 270° C. The ΔHf can be up to 35, up to 30, or up to 25 Joule/gram. More specifically, melting temperature, Tm, can be determined from dynamic scanning calorimetry (DSC) by placing the sample of the polymer in a pan, equilibrating it at room temperature and then ramping the temperature to 300° C. at a rate of 10° C./min. The melting temperature is taken as the lowest point on the curve of where the endotherm indicating melting appears. The ΔHf can be determined from the DSC curve by integration of the are beginning where the endotherm starts to where the endotherm ends.

The pads can yield improved removal rate during polishing and can tolerate higher polishing pressures and polishing speeds. Furthermore, the polishing pad can achieve improved performance with a polishing pad that is hydrophilic during polishing. Achieving a hydrophilic polishing pad during polishing facilitates achieving a thin and efficient pad-wafer gap for efficient polishing. The addition of fluorine-containing copolymers decreases the pad's electronegativity or zeta potential, which makes the pad surface very hydrophilic during polishing.

The hard phase comprises the rigid hard segments that provide stiffness. The hard phase can be partially crystalline and partially amorphous. The amorphous portion has a relatively high glass transition temperature (Tg) as compared to the soft phase (soft segments). The Tg of the hard phase can be, for example, in the range of 100 to 170° C. Due to the partial crystalline structure of the hard phase a melting temperature, Tm, is also observed for the hard phase. The melting temperature of the polyurea can be at least 230° C. The Tg can be determined by dynamic mechanical analysis (DMA).

The soft phase comprises segments generally having a low Tg relative to the Tg of the hard phase segments and are more flexible at room temperature. Phase separation occurs due to immiscibility between the hard and soft segments. The Tg of the soft phase can be, for example, in the range of −40 to 130° C.

The hard and soft segments are crosslinked with a polyamine (e.g., a diamine). The amine groups react with the isocyanate groups of the hard segment component (e.g., prepolymer) and the soft segment (e.g., prepolymer) forming the urea linkages of the polyurea.

The soft phase can be formed from a soft segment having one or more aliphatic fluorine-free species (e.g., monomer, dimer, trimer, or higher oligomer) and at least one fluorinated species (e.g., monomer, or a macromolecule such as an oligomer) each having two reactive end groups. The fluorinated species can have a length of at least 6, at least 8, up to 20, or 16 carbon atoms. For example, the fluorinated species can include a macromolecule (e.g., oligomer) of a fluorinated alkylene oxide and a non-fluorinate alkylene oxide. The aliphatic fluorine-free polymer groups are bonded with the reactive end groups of the at least one fluorinated species. The linkage can be a nitrogen-containing linkage. Examples of nitrogen-containing linkages include urea and urethane groups. The aliphatic fluorine-free polymer groups have one end attached to the at least one fluorinated species nitrogen-containing linkage. An isocyanate group can cap the reaction ends of the aliphatic fluorine-free polymer groups. Typically, the aliphatic fluorine-free polymer species that are reacting can have a number average molecular weight 200 to 7500, or 250 to 5000, e.g. as measure by Gel Permeation Chromatography (GPC) or specified on product literature. For purposes of clarity, the number average molecular weight of the aliphatic fluorine-free polymer groups end does not include any of the following: isocyanate end groups, nitrogen-containing linkages or the amine curative. The soft segment forms a soft phase within the polyurea matrix. The aliphatic fluorine-free polymer group can be a polytetramethylene ether that links with the fluorinated species. The fluorinated species can include at least one fluorinated ether. The fluorinated species can comprise the reaction product of fluorinated ethylene oxide, fluorinated oxymethylene and ethylene oxide. The atomic ratio of fluorinated ether groups such as fluorinated ethylene oxide and fluorinated oxymethylene to ethylene oxide can be less than 3.

The hard phase can be formed from a diisocyanate-containing hard segment that does not contain a fluorine group and an amine-containing curative agent. The hard segment can include a urea group formed from the isocyanate group capping outer ends of the aliphatic fluorine-free polymer groups reacted with an amine-containing curative agent. The hard segments can agglomerate as a hard phase within the soft phase. This morphology provides a fluorine-rich phase (that can improve ceria interactions) and a hard phase for strengthening the soft phase to improve polishing asperity integrity for enhanced pad life and stability while polishing multiple wafers. The hard segment (e.g. isocyanate or urea portion) and soft segment can form a prepolymer before reaction of that prepolymer with the amine-containing curative agent to form the polyurea matrix. The presence of fluorine containing moieties in the soft segment increases the soft segment glass transition temperature (Tg) of the soft phase. This unexpected increase in glass transition temperature increases thermal stability of the polymer.

At the very upper surface of the polymer in air, enrichment of the fluorinated soft segment components can occur during polishing. This in situ and continuous generation of fluorine rich phase at the surface further enhances the beneficial impact of a minor amount of fluoropolymer. At relatively low fluorinated soft segment concentrations (for example, below 20 wt % of the total soft segment content), the amount of fluorinated species is insufficient to prevent water molecular dipole rearrangement when the polymer is subsequently exposed to water, especially under shear. This results in a complex wetting behavior when the droplet is exposed to shear. Specifically, the water surface is believed to rearrange giving rise to increased water interaction with the hydrophilic portions of the polymer. This results in a reduction in the receding contact angle of the droplet and a corresponding increase in the surface energy during polishing. The result is that, under shear, the polishing pad disclosed herein can be even more hydrophilic than its fluorine-free analog.

The polyurea used in the polishing layer of the polishing pads disclosed herein are block copolymers. An isocyanate terminated urethane prepolymer that can be used in the formation of the polishing layer of the chemical mechanical polishing pad disclosed herein can comprise: a reaction product of ingredients, comprising: a polyfunctional isocyanate and a prepolymer mixture containing two or more components, one of which is fluorinated.

The isocyanate is polyfunctional, for example, a diisocyanate. Examples of diisocyanates include 2,4-toluene diisocyanate; 2,6-toluene diisocyanate; 4,4′ diphenylmethane diisocyanate; naphthalene-1,5-diisocyanate; toluidine diisocyanate; para-phenylene diisocyanate; xylylene diisocyanate; isophorone diisocyanate; hexamethylene diisocyanate; 4,4′-dicyclohexylmethane diisocyanate; cyclohexanediisocyanate; and mixtures thereof. The diisocyanate can be toluene diisocyanate.

The aliphatic fluorine-free polymer groups can be reacted from the group consisting of diols, polyols, polyol diols, copolymers thereof, and mixtures thereof. For example, it is possible to react the aliphatic fluorine-free polymer groups with a diisocyanate and then link the fluorinated species to the diisocyanate. A prepolymer polyol can be selected from the group consisting of polyether polyols (e.g., polyakylene glycols where the alkylene comprises 2 to 5 carbon atoms, such as poly(oxytetramethylene) glycol, poly(oxypropylene) glycol, polyoxyethylene) glycol); polycarbonate polyols; polyester polyols; polycaprolactone polyols; mixtures thereof; mixtures of one or more thereof with one or more low molecular weight polyols selected from the group consisting of ethylene glycol; 1,2-propylene glycol; 1,3-propylene glycol; 1,2-butanediol; 1,3-butanediol; 2-methyl 1,3-propanediol; 1,4-butanediol; neopentyl glycol; 1,5-pentanediol; 3-methyl-1,5-pentanediol; 1,6-hexanediol; diethylene glycol; dipropylene glycol; and, tripropylene glycol. The prepolymer polyol can be polytetramethylene ether glycol (PTMEG); polypropylene ether glycols (PPG), polyethylene ether glycols (PEG); or mixtures thereof optionally, mixed with one or more low molecular weight polyol selected such as ethylene glycol; 1,2-propylene glycol; 1,3-propylene glycol; 1,2-butanediol; 1,3-butanediol; 2-methyl-1,3-propanediol; 1,4-butanediol; neopentyl glycol; 1,5-pentanediol; 3-methyl-1,5-pentanediol; 1,6-hexanediol; diethylene glycol; dipropylene glycol; and tripropylene glycol. The prepolymer polyol can be primarily (e.g., >90 wt %) polytetramethylene ether. The fluorinated polyol can be made from any of the unfluorinated polyols cited above, with fluorine added via replacement. This creates minimal variation in the final mechanical properties.

The isocyanate terminated urethane prepolymer can have an unreacted isocyanate (NCO) concentration of 8.5 to 9.5 wt %. Examples of commercially available isocyanate terminated urethane prepolymers include Imuthane™ prepolymers (available from COIM USA, Inc., such as, PET-80A, PET-85A, PET-90A, PET-93A, PET-95A, PET-60D, PET-70D, PET-75D); Adiprene™ prepolymers (available from Chemtura, such as, LF-800A, LF-900A, LF-910A, LF-930A, LF-931A, LF-939A, LF-950A, LF-952A, LF-600D, LF-601D, LF-650D, LF-667, LF-700D, LF-750D, LF-751D, LF-752D, LF-753D and L325); Andur™ prepolymers (available from Anderson Development Company, such as, 70APLF, 80APLF, 85APLF, 90APLF, 95APLF, 60DPLF, 70APLF, 75APLF).

The isocyanate terminated urethane prepolymer can be a low free isocyanate terminated urethane prepolymer having less than 0.1 wt % free toluene diisocyanate (TDI) monomer content.

The inventors discovered that selection of the curative agent used in the formation of the polishing layer can enable the formation of crystallinity in the hard phase and can increase the melting temperature, Tm. Particularly, a curative agent that comprises a curative of the formula I:

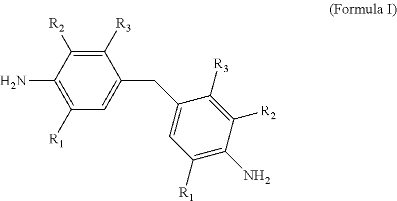

wherein R₁, R₂, and R₃ are selected from H, halogen (preferably fluorine or chlorine, more preferably chlorine) and alkyl groups of 1-3, preferably 2, carbon atoms, provided at least one of R₁, R₂, and R₃, preferably R₁ and R₂ are alkyl groups of 1-3, preferably 2, carbon atoms, and provided there is not more than one halogen per aromatic ring.

For example the curative agent can be Bis(4-amino-2-chloro-3,5-diethylphenyl)methane (“MCDEA”).

The curative agent of formula I, for example MCDEA, can be used in amounts of from 30, from 40, from 45 up to 100, up to 95, up to 90, or up to 80 mole percent based on total amount of curative of can achieve the desired thermal stability.

In addition to the curative agent of formula I, e.g., MCDEA, the curative agent can include one or more additional polyfunctional aromatic amines. Examples of such additional polyfunctional aromatic amines are diethyltoluenediamine (DETDA); 3,5-dimethylthio-2,4-toluenediamine and isomers thereof, 3,5-diethyltoluene-2,4-diamine and isomers thereof (e.g., 3,5-diethyltoluene-2,6-diamine); 4,4′-bis-(sec-butylamino) diphenylmethane; 1,4-bis-(sec-butylamino)-benzene, 4,4′-methylene-bis-(2-chloroaniline) polytetramethyleneoxide-di-p-aminobenzoate; N,N-dialkyl diamino diphenyl methane; p,p′-methylene dianiline (MDA); m-phenylenediamine (MPDA); 4,4′-methylene-bis(2-chloroaniline) (MBOCA); 4,4′-methylene-bis-(2,6-diethylaniline) (MDEA); 4,4′-methylene-bis-(2,3-dichloroaniline) (MDCA); 4,4′-diamino-3,3′-diethyl-5,5′-dimethyl diphenylmethane, 2,2′,3,3-tetrachloro diamino diphenyl methane; trimethylene glycol di-p-aminobenzoate; and mixtures thereof.

The polishing pads disclosed herein can be made by methods comprising: providing the isocyanate terminated urethane prepolymer; providing separately the curative component; and combining the isocyanate terminated urethane prepolymer and the curative component to form a combination; allowing the combination to react to form a product; forming a polishing layer from the product, such as by skiving the product to form a polishing layer of a desired thickness and grooving the polishing layer, such as by machining it and forming the chemical mechanical polishing pad with the polishing layer.

The polishing layer of the chemical mechanical polishing pad disclosed herein can further contain a plurality of microelements. The microelements can be uniformly dispersed throughout the polishing layer or can be dispersed according to a gradient from top to bottom of the polishing layer. The microelements can be, for example, entrapped gas bubbles, hollow core polymeric materials, liquid filled hollow core polymeric materials, water soluble materials and an insoluble phase material (e.g., mineral oil). More particularly, the plurality of microelements can be selected from entrapped gas bubbles and hollow core polymeric materials uniformly distributed throughout the polishing layer. The plurality of microelements can have a weight average diameter of less than 150 μm, or equal to or less than 50 μm; and at least 1 or at least 10 μm. For example, the plurality of microelements can be polymeric microballoons with shell walls of either polyacrylonitrile or a vinylidene chloride-polyacrylonitrile copolymer (such as, e.g., Expancel™ microspheres from Akzo Nobel). The plurality of microelements that provide porosity can be incorporated into the polishing layer to yield from 0 to 50 volume % porosity or 10 to 35 volume % porosity. The volume % of porosity can be determined by dividing the difference between the specific gravity of an unfilled polishing layer and specific gravity of the microelement containing polishing layer by the specific gravity of the unfilled polishing layer.

The polishing layer of the polishing pad disclosed herein can be provided in porous or nonporous (i.e., unfilled) configurations. The polishing layer of the chemical mechanical polishing pad disclosed herein can have a density of 0.4 to 1.15 g/cm³, or 0.70 to 1.0 g/cm³; as measured according to ASTM D1622 (2014)).

The polishing layer of the chemical mechanical polishing pad disclosed herein can have a Shore D hardness of 28 to 75 as measured according to ASTM D2240 (2015).

The polishing layer can have an average thickness of 20 to 150 mils (0.05 to 0.4 cm), 30 to 125 mils (0.08 to 0.3 cm, 40 to 120 mils (0.1 to 0.3 cm), or 50 to 100 mils (0.13 to 0.25 cm).

The polishing pad disclosed herein can be adapted to be interfaced with a platen of a polishing machine. For example, the CMP polishing pad can be adapted to be affixed (e.g., using at least one of a pressure sensitive adhesive or vacuum) to the platen of a polishing machine.

The polishing pad disclosed herein optionally further comprises at least one additional layer interfaced with the polishing layer. For example, the CMP polishing pad optionally can further comprise a compressible base layer adhered to the polishing layer. The compressible base layer can improve conformance of the polishing layer to the surface of the substrate being polished. This conformance can improve polishing removal rate a global uniformity.

The polishing pad disclosed herein in its final form can further include texture in one or more dimensions on its upper surface. Such texture may be classified by their size into macrotexture or microtexture. Macrotexture can facilitate control of hydrodynamic response and slurry transport. Macrotexture can include, without limitation, grooves of many configurations and designs, such as annular, radial, biased radial and cross-hatchings, protrusions (e.g., columns, pyramids of varying shape) arranged in regular or occurrence or annular or radial pattern, or the like. These may be formed directly on the pad by molding or by machining processes on a thin uniform sheet. Microtexture comprises finer scale features that create a population of surface asperities that are the points of contact with the substrate wafer where polishing occurs. For example, microtexture can include, without limitation, texture formed by abrasion with an array of hard particles, such as diamond (often referred to as pad conditioning), either prior to, during or after use, and microtexture formed during the pad fabrication process.

Unlike porous pads, non-porous pads have increased stiffness for improved planarization efficiency, reduced dishing and lower wear rates. Since the non-porous pads polish differently than porous pads, they typically require a different groove pattern and different diamond conditioners for producing a viable CMP pad. Without a proper groove pattern and microtexture, these pads are prone to hydroplaning and glazing of the polishing pad's surface. Glazing is where pads wear or deform to reduce texture. For example, severe glazing is where the pad loses all its microtexture.

CMP polishing pads are used in conjunction with a polishing slurry, as described in the Background herein. The polishing pads disclosed herein can particularly be used with such slurries and particularly with slurries whose pH is below the isoelectric point pH of the particle being used. For example, ceria has an isoelectric pH of approximately 6.6. Below this pH, the particle surface has a net positive charge. Above this pH, the particle has a net negative charge. Since pads disclosed herein can exhibit a high negative charge at that pH, the rate enhancement is achieved when the particles are below the isoelectric point.

The polishing pads disclosed herein may be manufactured by a variety of processes that are compatible with thermoset urethanes. These include mixing the ingredients as described above and casting into a mold, annealed, and sliced into sheets of the desired thickness. Alternatively, they may be made in a more precise net shape form. For example, the following process can be used: 1. thermoset injection molding (often referred to as “reaction injection molding” or “RIM′); 2. thermoplastic or thermoset injection blow molding; 3. compression molding; or 4. any similar-type process in which a flowable material is positioned and solidified, thereby creating at least a portion of a pad's macrotexture or microtexture. In a molding example: 1. the flowable material is forced into or onto a structure or substrate; 2. the structure or substrate imparts a surface texture into the material as it solidifies, and 3. the structure or substrate is thereafter separated from the solidified material.

### EXAMPLES

### Materials

### Materials

The PTMEG was a blend of various PTMEGs having a molecular weight ranging from 250 to 2000.

4,4′-Dicyclohexylmethane diisocyanate (H12MDI).

Toluene diisocyanate (TDI).

Toluene diisocyanate (“H12MDI/TDI”) PTMEG was prepolymer having an NCO of 8.95 to 9.25 wt %.

The polymeric microspheres were vinylidene chloride-polyacrylonitrile copolymer microspheres, having an average particle diameter of about 20 μm.

The fluoropolymer was an ethoxylated perfluoroether. The fluoropolymer had a linear structure of fluorinated ethylene oxide-fluorinated oxymethylene capped with ethylene oxide. The atomic ratio “R” of fluorinated ether to ethylene oxide was either 1.9 or 5.3.

MCDEA was Bis(4-amino-2-chloro-3,5-diethylphenyl)methane

MBOCA was 4,4′-methylene-bis(2-chloroaniline).

### Synthesis of Prepolymers Procedure

Prepolymers were synthesized in batches ranging from approximately 200 to 1000 gram. The ethoxylated perfluoroether and PTMEG were mixed to yield the desired level of fluorination of polytetramethyl ether. TDI and H12MDI were mixed at 80:20 weight ratio before adding to the mixture. Enough isocyanate mixture was then added to the mixture of ethoxylated perfluoroether and PTMEG to achieve the desired NCO wt %. The whole mixture was again mixed and then placed in a pre-heated oven at 65° C. for 4 hours before use.

### Pad Production Procedure

The synthesized prepolymers and (“H12MDI/TDI”) PTMEG prepolymer were heated to 65° C. A cure agent was pre-weighted and melted in oven at 110° C. Polymeric microspheres were added to the prepolymers after the 4 hour reaction time or once heated and degassed with polymeric microspheres in prepolymer via vacuum. All filled samples include a distribution of polymeric microspheres sufficient to reach either a specific gravity or final density. After degassing and once both components were at temperature, the cure agent was added to the prepolymer and mixed. After mixing, the sample was poured onto a heated plate and drawn using a Teflon™ coated bar with a spacer set at 175 mil (4.4 mm). The plate was then transferred into an oven and heated to 104° C. and held at temperature for 16 hours. The drawdown was then demolded and punched down to 22 inches (55.9 cm) and used to prepare a laminated pad for polishing. All pads were 30″ (76 cm) in diameter with an 80 mil (2.0 mm) top pad, 1010 circular grooving having a width, depth and pitch of 20 mils, 30 mils, and 120 mils (0.51 mm, 0.76 mm and 3.05 mm), respectively, pressure sensitive adhesive film for the subpad, Suba IV™ polyurethane impregnated polyester felt subpad, and pressure sensitive platen adhesive. Plaques of each material set were also made into plaques for property testing both with and without the polymeric microsphere filler for property testing.

### Example 1

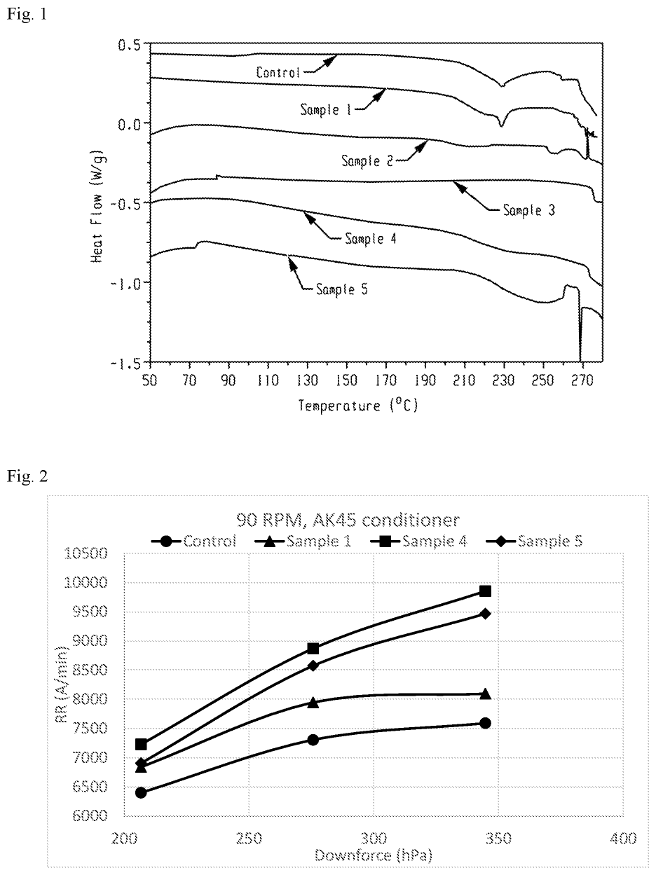

Polymers made from the above prepolymer (or for Control with (“H12MDI/TDI”) PTMEG prepolymer that was not fluorinated) and with various curative agents (as indicated in Table 1) were tested by Dynamic Scanning Calorimetry (DSC) placing a 30 milligram sample in an aluminum pan and then being ramped from room temperature to 280° C. or to 300° C. at a rate of 10° C./minute. The DSC thermograph is shown in FIG. 1. Note that the curve for each polymer in FIG. 1 shows relative heat flow during the process (i.e., the y-axis is showing relative heat flow) and that the curve for each polymer is offset for clarity of viewing. In other words, for example, the Control polymer does not have a higher heat flow overall than the other polymers but the curve is offset so that each curve can be viewed without overlapping another curve. Melting temperature in Table 1 is the lowest point on the DSC curve in the range where a decrease indicating melting (i.e. the endotherm) was seen. Delta Hf (ΔH_{f}, or enthalpy of formation) was determined by integration of the endotherm on the curve beginning where the endotherm starts to where the endotherm ends.

TABLE 1

| | | Melting | |
|---|---|---|---|
| | | Temperature | ΔH_{f} |
| Sample # | Curative agent | (° C.) | (Joules/gram) |
| Control | 100% MBOCA | 228 | 13.3 |
| 1 (comparative) | 100% MBOCA | 228 | 12.6 |
| 2 (comparative) | 10 mol % MCDEA/ | 211 | 2.4 |
| | 90 mol % MBOCA | | |
| 3 (comparative) | 25 mol % MCDEA/ | — | — |
| | 75 mol % MBOCA | | |
| 4 | 50 mol % MCDEA/ | 230 | 5 |
| | 50 mol % MBOCA | | |
| 5 | 100% MCDEA | 250 | 21.6 |

As can be seen at 25% MCDEA and 75% MBOCA the thermograph curve of Sample 3 shows no melting temperature indicating an amorphous polymer—particularly an amorphous hard phase. Samples 4 and 5 demonstrate that higher amounts of MCDEA yield a polymer with some crystallinity and increased melting temperature relative to polymers having 75% or more MBOCA. The amount of crystallinity as indicated by ΔH_{f} increases as the amount of MCDEA increases above 25 mol %.

### Example 2

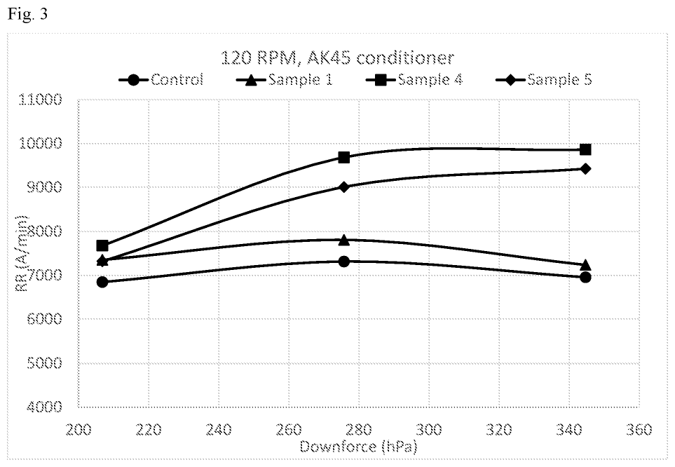

Pads were produced as described above using the curative agent as follows: Sample 1 (100% MBOCA), Sample 4 (50 mol % MBOCA/50 mol % MCDEA), and Sample 5 (1000/MCDEA). A commercial pad (IK4250 from DuPont) was also tested as a control. The pads were tested on an AMAT Reflexion polisher using HS-0220 (from Hitachi) slurry, and an AK45 (from Saesol) conditioner, polishing a silicon oxide substrate at various platen speeds and pressures. As shown in FIG. 2, at 90 RPM the inventive pad samples 4 and 5 do not show the plateau on removal rate at down force pressures above about 275 hPa (hectoPascals) as is seen in the control pad and Sample 1. Similarly, in FIG. 3 at 120 RPM platen, Samples 4 and 5 begin to plateau in removal rate while Sample 1 and the Control pad actually decreased in removal rate at pressures above about 275 hPa). The improved performance of inventive samples 4 and 5 may have been due to the improved thermal stability (e.g., higher melting point) of the polymers enabling them to tolerate higher process temperatures during polishing at higher pressures and speeds.

This disclosure further encompasses the following aspects.

Aspect 1: A polishing pad suitable for polishing at least one of semiconductor, optical, magnetic or electromechanical substrates comprising: a polishing layer including a polyurea having a soft phase and a hard phase, the soft phase being a copolymer of aliphatic fluorine-free species and a fluorinated aliphatic species, the polyurea being cured with a curing agent where the hard phase comprises crystallinity where the polyurea is characterized by a melting point of at least 230° C. and a ΔH_{f} of at least 3, preferably at least 3.5, more preferably at least 4, yet more preferably at least 4.5 Joule/gram as determined by Dynamic Scanning Calorimetry of the polyurea.

Aspect 2: The polishing pad of Aspect 1 wherein the melting point is less than 280° C.

Aspect 3: The polishing pad of Aspect 1 or 2 wherein the ΔH_{f} is no greater than 35, preferably no greater than 30, more preferably no greater than 25 Joules/gram.

Aspect 4: The polishing pad of any of the previous aspects wherein the polyurea of the polishing layer forms a matrix and the polishing layer further comprises gas or liquid-filled polymeric microelements dispersed in the matrix.

Aspect 5: The polishing pad of any of the previous aspects wherein the curing agent comprises a curative of formula I:

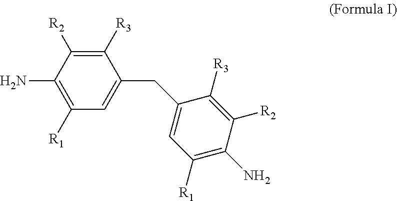

wherein R₁, R₂, and R₃ are selected from H, halogen (preferably fluorine or chlorine, more preferably chlorine) and alkyl groups of 1-3, preferably 2, carbon atoms, provided at least one of R₁, R₂, and R₃, preferably R₁ and R₂ are alkyl groups of 1-3, preferably 2, carbon atoms, and provided there is not more than one halogen per aromatic ring.

Aspect 6: The polishing pad of any of the previous aspects wherein the curative of formula I is 4,4′-methylene-bis-(3-chloro-2,6-diethylaniline).

Aspect 7: The polishing pad of any of the previous aspects wherein the amount of curative of formula I in the curing agent is from 30, preferably from 35, more preferably from 40, yet more preferably from 45 up to 100, preferably up to 95, more preferably up to 90, and yet more preferably up to 80 mole percent of the curing agent.

Aspect 8: The polishing pad of any of the previous aspects wherein the curing agent further comprises one or more additional curatives selected from diethyltoluenediamine (DETDA); 3,5-dimethylthio-2,4-toluenediamine and isomers thereof; 3,5-diethyltoluene-2,4-diamine and isomers thereof (e.g., 3,5-diethyltoluene-2,6-diamine); 4,4′-bis-(sec-butylamino) diphenylmethane; 1,4-bis-(sec-butylamino)-benzene, 4,4′-methylene-bis-(2-chloroaniline) polytetramethyleneoxide-di-p-aminobenzoate; N,N-dialkyl diamino diphenyl methane; p,p′-methylene dianiline (MDA); m-phenylenediamine (MPDA); 4,4′-methylene-bis(2-chloroaniline) (MBOCA); 4,4′-methylene-bis-(2,6-diethylaniline) (MDEA); 4,4′-methylene-bis-(2,3-dichloroaniline) (MDCA); 4,4′-diamino-3,3′-diethyl-5,5′-dimethyl diphenylmethane, 2,2′,3,3-tetrachloro diamino diphenyl methane; trimethylene glycol di-p-aminobenzoate.

Aspect 9: The polishing pad of any of the previous aspects wherein the copolymer of the soft phase has a structure containing fluorinated alkylene oxide and a non-fluorinated alkylene oxide.

Aspect 10: The polishing pad of aspect 9 wherein the mole ratio of fluorinated alkylene oxide to non-fluorinated alkylene oxide is less than 3.

Aspect 11: The polishing pad of any of the previous aspects wherein the aliphatic fluorine-free species is a polytetramethylene ether.

Aspect 12: The polishing pad of any of the previous aspects wherein the hard phase comprises the reaction product of diisocyanate hard segments and a curative agent.

Aspect 13: The polishing pad of any of the previous aspects wherein the polishing layer has a polishing surface comprising macrotexture.

Aspect 14: The polishing pad of any of the previous aspects characterized in that removal rate at 120 rotations per minute (RPM) at pressure of 345 hPa) is the same or higher than the removal rate at 275 hPa).

Aspect 15: The polishing pad of any of the previous aspects characterized in that the polishing layer remains hydrophilic during polishing in shear conditions.

Aspect 16: A method comprising providing a substrate to be polished and polishing the substrate using the polishing pad of any one of Aspect 1-15.

Aspect 17: The method of Aspect 16 wherein the method comprises applying a slurry between the substrate and the polishing pad.

Aspect 18: The method of Aspect 17 wherein the slurry comprises ceria.

Aspect 19: The method of any one of aspects 16-18 wherein the substrate comprises on a surface silicon dioxide.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). Moreover, stated upper and lower limits can be combined to form ranges (e.g. “at least 1 or at least 2 wt. %” and “up to 10 or 5 wt. %” can be combined as the ranges “1 to 10 wt. %”, or “1 to 5 wt. %” or “2 to 10 wt. %” or “2 to 5 wt. %”).

The disclosure may alternately comprise, consist of, or consist essentially of, any appropriate components herein disclosed. The disclosure may additionally, or alternatively, be formulated so as to be devoid, or substantially free, of any components, materials, ingredients, adjuvants or species used in the prior art compositions or that are otherwise not necessary to the achievement of the function or objectives of the present disclosure.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

What is claimed is:

1. A polishing pad suitable for polishing at least one of semiconductor, optical, magnetic
or electromechanical substrates comprising:
a polishing layer including a polyurea having a soft phase and a hard phase, the soft phase being a copolymer of aliphatic fluorine-free species and a fluorinated aliphatic species, the polyurea being cured with a curing agent where the hard phase comprises crystallinity where the polyurea is characterized by a melting point of at least 230° C. and a ΔH_{f} of at least 3 Joule/gram as determined by Dynamic Scanning Calorimetry of the polyurea.

2. The polishing pad of claim 1 wherein the polyurea of the polishing layer forms a matrix and the polishing layer further comprises gas or liquid-filled polymeric microelements dispersed in the matrix.

3. The polishing pad of claim 1 wherein the curing agent comprises no less than 30 mole percent based on total moles of curing agent, of a curative of formula I: 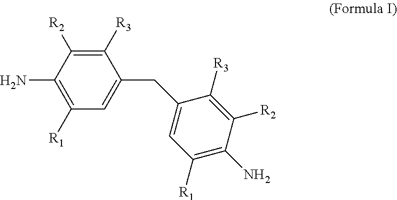
wherein R₁, R₂, and R₃ are selected from H, halogen and alkyl groups of 1-3, provided at least one of R₁, R₂, and R₃, are alkyl groups of 1-3 carbon atoms, and provided there is not more than one halogen per aromatic ring.

4. The polishing pad of claim 3 wherein the curative of formula I is 4,4′-methylene-bis-(3-chloro-2,6-diethylaniline).

5. The polishing pad of claim 3 wherein the curing agent further comprises one or more additional curatives selected from diethyltoluenediamine (DETDA); 3,5-dimethylthio-2,4-toluenediamine and isomers thereof, 3,5-diethyltoluene-2,4-diamine and isomers thereof (e.g., 3,5-diethyltoluene-2,6-diamine); 4,4′-bis-(sec-butylamino) diphenylmethane; 1,4-bis-(sec-butylamino)-benzene, 4,4′-methylene-bis-(2-chloroaniline) polytetramethyleneoxide-di-p-aminobenzoate; N,N-dialkyl diamino diphenyl methane; p,p′-methylene dianiline (MDA); m-phenylenediamine (MPDA); 4,4′-methylene-bis(2-chloroaniline) (MBOCA); 4,4′-methylene-bis-(2,6-diethylaniline) (MDEA); 4,4′-methylene-bis-(2,3-dichloroaniline) (MDCA); 4,4′-diamino-3,3′-diethyl-5,5′-dimethyl diphenylmethane, 2,2′,3,3-tetrachloro diamino diphenyl methane; trimethylene glycol di-p-aminobenzoate.

6. The polishing pad of claim 1 wherein the copolymer of the soft phase has a structure containing fluorinated alkylene oxide and a non-fluorinated alkylene oxide,
wherein the mole ratio of fluorinated alkylene oxide to non-fluorinated alkylene oxide is less than 3.

7. The polishing pad of claim 1 wherein the aliphatic fluorine-free polymer group is a polytetramethylene ether and wherein the hard phase comprises the reaction product of diisocyanate hard segments and a curative agent.

8. The polishing pad of claim 1 wherein the polishing layer has a polishing surface comprising macrotexture.

9. The polishing pad of claim 1 characterized in that removal rate at 120 rotations per minute at pressure of 346 hectoPascals is the same or higher than the removal rate at 275 hetcoPascals.

10. The polishing pad of claim 1 characterized in that the polishing layer remains hydrophilic during polishing in shear conditions.
